(19) United States
(12) Patent Application Publication
(10) Pub. No.: US 2026/0199981 A1
(43) Pub. Date: Jul. 16, 2026

(54) Additive Manufacturing Condition Determination Device, Additive Manufacturing Condition Determination Method, and Additive Product Manufacturing Method

(71) Applicant: Hitachi, Ltd., Chiyoda-ku, Tokyo (JP)

(72) Inventors: Hirotsugu KAWANAKA, Tokyo (JP); Tomonori KIMURA, Tokyo (JP); Isamu TAKAHASHI, Tokyo (JP); Yusuke YASUDA, Tokyo (JP); Seunghwan PARK, Tokyo (JP)

(21) Appl. No.: 19/135,409

(22) PCT Filed: Jan. 11, 2024
(86) PCT No.: PCT/JP2024/000359

§ 371 Date: Jun. 4, 2025

(30) Foreign Application Priority Data
Mar. 22, 2023 (JP) 2023-045194

(51) Int. Cl. B22F 10/85; B22F 10/14; B22F 10/64; B22F 10/68; B33Y 40/20; B33Y 50/02

(52) U.S. Cl. CPC B22F 10/85; B22F 10/14; B22F 10/64; B22F 10/68; B33Y 40/20; B33Y 50/02

(57) ABSTRACT

Provided is an additive manufacturing condition determination device capable of manufacturing a structure having a desired shape and density. In order to solve this problem, a determination device includes a first condition determination unit configured to determine, based on a shape and a density of a first structure manufactured by stacking and resin curing performed during additive manufacturing by a binder jetting method, a first manufacturing condition at the time of the stacking and the resin curing for manufacturing the first structure having a desired shape and density; and a second condition determination unit configured to determine, based on a shape and a density of a second structure manufactured by degreasing and sintering performed during the additive manufacturing, a second manufacturing condition at the time of the degreasing and the sintering for manufacturing a second structure having a desired shape and density using the manufactured desired first structure.

### TECHNICAL FIELD

The present disclosure relates to an additive manufacturing condition determination device, an additive manufacturing condition determination method, and an additive product manufacturing method.

### BACKGROUND ART

It is known that additive manufacturing (stacked molding) includes, for example, a powder bed fusion method and a directed energy deposition method. In the powder bed fusion method, additive manufacturing is performed by irradiating a powder material (for example, a metal powder) spread flat with a light beam (a laser beam, an electron beam, or the like). The powder bed fusion method includes selective laser melting (SLM), electron beam melting (EBM), and the like. In the directed energy deposition method, additive manufacturing is performed by controlling a position of a head that emits a light beam and dispenses a powder material. The directed energy deposition method includes laser metal deposition (LMD), direct metal deposition (DMP), and the like.

As another method, there is a binder jetting method. In the powder bed fusion method and the directed energy deposition method, an additive product (stacked molded object) is formed by directly melting and solidifying a powder material using a beam as a heat source. On the other hand, in the binder jetting method, a binder is applied to a powder material (for example, a metal powder) according to a molding shape, and accordingly, the powder materials are bonded to each other. Next, after the binder is removed (degreasing heat treatment), sintering heat treatment is performed to manufacture a three-dimensionally shaped component.

Metal injection molding (MIM) is an example of a manufacturing method similar to the binder jetting method. In the MIM, a metal powder and a binder (a binding material, a plasticizer, and a lubricant) are pressurized and kneaded to manufacture a pellet (compound). Next, the pellet is placed in an injection molding machine and plasticized by applying a temperature, and a MIM material is injection-molded in a cavity of a mold. A molded body is referred to as a green part, and a molded body obtained by degreasing and overheating a solvent is referred to as a brown part. By sintering the brown part, a sintered product referred to as a silver part is obtained.

In the additive manufacturing, it is preferable to set appropriate manufacturing conditions (recipes) for additive manufacturing according to conditions such as materials and manufacturing devices. As a technique related to determination of a manufacturing condition, claim 1 of PTL 1 discloses that “a machine learning device including: a data acquisition unit configured to acquire first data including shape data representing a target shape of a three-dimensional molded object and additional shape data representing a target shape of an additional portion to be added to the three-dimensional molded object to prevent deformation of the three-dimensional molded object during manufacturing, and second data related to the deformation of the three-dimensional molded object; a storage unit configured to store a training data set including a plurality of pieces of the first data and a plurality of pieces of the second data; and a learning unit configured to learn a relationship between the first data and the second data by executing machine learning using the training data set”.

### CITATION LIST

### Patent Literature

PTL 1: JP 2022-021956A

### SUMMARY OF INVENTION

### Technical Problem

In the technique described in PTL 1, a target shape of an additional portion to be added to a three-dimensional structure is corrected by predicting a manufacturing error of a finally obtained three-dimensional molded object (paragraph 0051). Therefore, in the technique described in PTL 1, a shape and a density of a structure (for example, an intermediate structure) in a manufacturing process of the three-dimensional structure to be finally obtained are not considered.

An object according to the present disclosure is to provide an additive manufacturing condition determination device, an additive manufacturing condition determination method, and an additive product manufacturing method capable of manufacturing a structure having a desired shape and density.

### Solution to Problem

An additive manufacturing condition determination device according to the present disclosure includes: a first condition determination unit configured to determine, based on a shape and a density of a first structure manufactured by stacking and resin curing performed during additive manufacturing by a binder jetting method, a first manufacturing condition at the time of the stacking and the resin curing for manufacturing the first structure having a desired shape and density; and a second condition determination unit configured to determine, based on a shape and a density of a second structure manufactured by degreasing and sintering performed during the additive manufacturing, a second manufacturing condition at the time of the degreasing and the sintering for manufacturing a second structure having a desired shape and density using the manufactured desired first structure. Other solutions will be described later in aspects for implementing the invention.

### Advantageous Effects of Invention

According to the present disclosure, it is possible to provide an additive manufacturing condition determination device, an additive manufacturing condition determination method, and an additive product manufacturing method capable of manufacturing a structure having a desired shape and density.

### BRIEF DESCRIPTION OF DRAWINGS

FIG. 1 is a block diagram of an additive manufacturing condition determination device according to the present disclosure.

FIG. 2 is a perspective view showing a shape of a green part to be used for evaluation.

FIG. 3 is a perspective view showing a shape of a silver part to be used for evaluation.

FIG. 4 is a flowchart showing an additive manufacturing method according to the present disclosure.

FIG. 5 is a block diagram showing a hardware structure of the additive manufacturing condition determination device according to the present disclosure.

FIG. 6 is a flowchart showing a first stage of an additive manufacturing condition determination method according to the present disclosure.

FIG. 7 is a flowchart showing a subsequent stage of the additive manufacturing condition determination method according to the present disclosure.

FIG. 8A is a schematic side view of an additive manufacturing device according to the present disclosure.

FIG. 8B is a schematic top view of the additive manufacturing device according to the present disclosure.

FIG. 9A is a schematic view showing an example of a powder spreading operation.

FIG. 9B is a schematic view showing an example of the powder spreading operation.

FIG. 9C is a schematic view showing an example of the powder spreading operation.

FIG. 9D is a schematic view showing an example of the powder spreading operation.

FIG. 10A is a schematic view showing an example of an application operation.

FIG. 10B is a schematic view showing an example of the application operation.

FIG. 11 shows an example of a drying operation.

### DESCRIPTION OF EMBODIMENTS

Hereinafter, aspects for implementing the disclosure (referred to as embodiments) will be described with reference to the drawings. In the following description of one embodiment, another embodiment applicable to the one embodiment will also be described as appropriate. The disclosure is not limited to the following one embodiment, and different embodiments can be combined with each other or freely modified without significantly impairing the effects of the disclosure. In addition, the same members are denoted by the same reference numerals, and redundant descriptions will be omitted. Further, those having the same function are denoted by the same name. The illustrated content is merely schematic, and for convenience of illustration, the actual configuration may be changed, and some members may be omitted or modified between drawings without significantly impairing the effects of the disclosure. Further, in the same embodiment, it is not always necessary to include all the configurations.

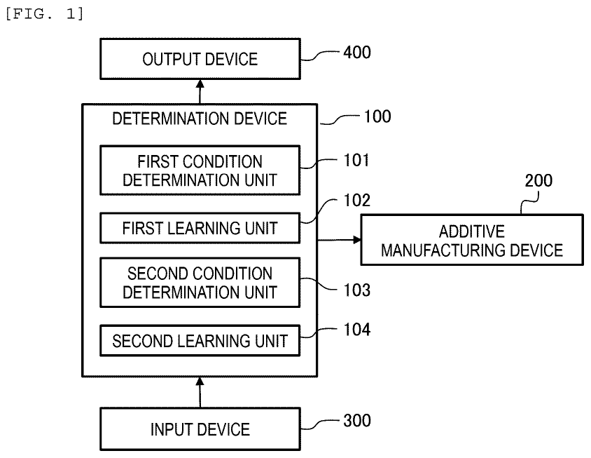

FIG. 1 is a block diagram of an additive manufacturing condition determination device 100 according to the present disclosure. FIG. 1 further shows an additive manufacturing device 200, an input device 300, and an output device 400.

Additive manufacturing by a binder jetting method roughly includes four steps. That is, each step of stacking (powder spreading, binder application, and drying), resin curing, degreasing, and sintering is included. A green part that is an intermediate structure is manufactured by stacking and resin curing. A silver part as a final structure is manufactured by degreasing and sintering the intermediate structure.

In order to optimize each of these steps, it is preferable to evaluate quality of a product (obtained structure) in each step. However, the evaluation itself of the product may be difficult due to circumstances such as a state of the product and convenience of the step. Therefore, in the example according to the present disclosure, a dimension, a mass, a density, and the like of the green part (intermediate structure), which is a molded object after resin curing and before degreasing, are measured. Further, a dimension, a weight, a density, and the like of a silver part (final structure) that is a molded object after a sintering step are also measured.

For example, by degreasing the green part, a density of the green part decreases by about 55% to 65%, and coupling becomes loose. A density 100% is defined as a state in which a powder material (for example, a metallic powder) to be used for additive manufacturing is densely filled. A final density of the silver part is higher than that of the green part after degreasing and is about 95% to 99%. As described above, during additive manufacturing, for example, large shrinkage deformation occurs in a binding process of powder metallurgy. Therefore, for example, a shrinkage ratio, an anisotropy, and a density change caused by sintering of the green part affect accuracy of a final shape of the silver part. Therefore, as in the present disclosure, it is preferable to also evaluate the shape and the density of the green part manufactured in a manufacturing process of the silver part.

The determination device 100 determines manufacturing conditions during additive manufacturing in the additive manufacturing device 200 that performs additive manufacturing by a binder jetting method. The manufacturing conditions include a first manufacturing condition for stacking and resin curing and a second manufacturing condition for degreasing and sintering. The manufacturing conditions include a large number of parameters (control factors to be described later). The parameters may also vary depending on a metal material to be used, a specification of the additive manufacturing device 200, and a shape and a density of a target final structure (silver part). Therefore, it is not easy to examine appropriate parameters each time manufacturing is performed and determine the manufacturing conditions each time. Therefore, by using the determination device 100, it is possible to search for an appropriate manufacturing condition and determine the manufacturing condition.

The determination device 100 includes a first condition determination unit 101, a first learning unit 102, a second condition determination unit 103, and a second learning unit 104.

The first condition determination unit 101 determines the first manufacturing condition based on the shape and the density of a first structure manufactured by stacking and resin curing performed during additive manufacturing by the binder jetting method. As described above, the first manufacturing condition is a manufacturing condition at the time of stacking and resin curing for manufacturing the first structure having a desired shape and density. The first structure is a structure (an intermediate structure) obtained in a manufacturing process of a second structure to be described later. By providing the first condition determination unit 101, the manufacturing condition of the first structure having the desired shape and density can be determined.

The first condition determination unit 101 determines, as the first manufacturing condition, manufacturing conditions during manufacturing of the first structure under which a dimensional difference and a density difference from a desired shape are both within predetermined ranges. The shape and the density of the actually manufactured first structure are compared with the desired shape and density, and if a difference therebetween is within the predetermined range, it can be determined that the manufactured first structure is close to the desired first structure. The difference here is a dimensional difference between corresponding sides in the case of the shape, and a density difference in the case of the density. Therefore, the first condition determination unit 101 can determine the manufacturing condition when the first structure can be manufactured as the first manufacturing condition when the first structure having the desired shape and density is manufactured.

The predetermined range here is an allowable dimensional difference and density difference assumed by stacking and resin curing. A specific numerical value of the predetermined range can be determined by, for example, an experiment.

FIG. 2 is a perspective view showing a shape of a green part 30 to be used for evaluation. For the green part 30, for example, the green part 30 is manufactured as the first structure under an initially set first manufacturing condition, and the first condition determination unit 101 determines the first manufacturing condition using the manufacturing condition, the shape and the density of the green part 30, and the like. Therefore, the green part 30 shown in FIG. 2 is a structure manufactured for determining the first manufacturing condition.

The green part 30 (the first structure) includes a plurality of unit structures 31, 32, and 33 having different volumes but a same shape. Therefore, the unit structures 31, 32, and 33 have a similar relationship. The unit structure 31, 32, and 33 has three types of block shapes of large, medium, and small. The block shape has sides that are made up of straight lines. With the block shape, a length of each side can be easily measured, and the dimensional difference can be easily calculated. Each of the unit structures 31, 32, and 33 is a cube in the shown example. By using the cube, it is possible to measure the dimension in each direction of x, y, and z-axis directions and evaluate the shrinkage in each direction caused by stacking or the like. In addition, the influence can be evaluated by a temperature distribution due to a difference in volume, a thermal stress due to the temperature distribution, the influence of processing unevenness, and the like. However, the shape is not limited to a cube.

The green part 30 further includes a unit structure 34. The unit structure 34 includes a support portion 341 and a pin-shaped portion 342 erected from the support portion 341. Therefore, the green part 30 includes the pin-shaped portion 342. As described above, the green part 30 is manufactured by the stacking of the powder material and the resin curing. Therefore, when the pin-shaped portion 342 has an elongated shape, it is difficult to stack the powder material. Even if the powder material can be stacked, the powder material is fragile and easily broken, and thus is easily damaged. Therefore, in order to determine and exclude the first manufacturing condition that causes such a phenomenon, the pin-shaped portion 342 is included.

A shape of the pin-shaped portion 342 (a columnar portion) is not limited, and may be, for example, a columnar shape having a length (a width) in a direction in which the powder material is spread (a direction perpendicular to a stacking direction) of, for example, 1 mm or more and 2 mm or less. The column may be a cylinder, an elliptical column, or a prism.

Returning to FIG. 1, the first condition determination unit 101 further determines, as the first manufacturing condition, a manufacturing condition when all density differences in the unit structures 31, 32, and 33 (FIG. 2) are within the predetermined range. For example, when each of the unit structures 31, 32, and 33 is stacked and resin cured, the density of each of the unit structures 31, 32, and 33 is lower than the density when the structure in which the powder material is densely present is set to 100%. However, since the shapes are the same but the volumes are different as described above, a degree of decrease may be different for each of the unit structure 31, 32, and 33. Therefore, by determining, as the first manufacturing condition, a manufacturing condition in which all density differences in the unit structure 31, 32, and 33 are within the predetermined range, it is possible to determine the first manufacturing condition in which a density change is substantially the same regardless of the volume. Accordingly, the density change can be reduced regardless of the volumes of the first structure and the second structure.

The predetermined range here is an allowable density difference assumed by the stacking and the resin curing. A specific numerical value of the predetermined range can be determined by, for example, an experiment. Regarding the density differences of the unit structures 31, 32, and 33, the density differences are preferably similar to each other as described above.

The first learning unit 102 performs machine learning using the first manufacturing condition, a shape of the intermediate structure, and a density of the intermediate structure as features. By providing the first learning unit 102, an evaluation result of the first structure associated with stacking and resin curing can be constructed as a database of learning conditions. The shape here is, for example, a dimension of a side forming the first structure. In the machine learning, for example, supervised learning using the first manufacturing condition as an objective variable and the shape and the density of the first structure as explanatory variables can be executed. However, the learning is not limited to the supervised learning, and may be unsupervised learning or reinforcement learning. As an algorithm of the machine learning, for example, Bayesian optimization, and kernel ridge regression analysis can be used.

The second condition determination unit 103 determines the second manufacturing condition based on the shape and the density of the second structure manufactured by the degreasing and sintering performed during the additive manufacturing. The second manufacturing condition is a manufacturing condition at the time of degreasing and sintering for manufacturing a second structure having a desired shape and density using the manufactured desired first structure. The second condition determination unit 103 can determine, based on the first structure having the desired shape and density, the manufacturing conditions for manufacturing the second structure (final structure, final product) having a desired shape and density.

Similarly to the first condition determination unit 101, the second condition determination unit 103 determines, as the second manufacturing condition, the manufacturing condition during manufacturing of the second structure in which the dimensional difference and the density difference from a desired shape are both within the predetermined ranges. The shape and the density of the actually manufactured second structure are compared with the desired shape and density, and if the difference therebetween is within the predetermined range, it can be determined that the shape and the density of the manufactured second structure are close to those of the desired second structure. The difference here is a dimensional difference between corresponding sides in the case of the shape, and a density difference in the case of the density. Therefore, the second condition determination unit 103 can determine the manufacturing condition when the second structure can be manufactured as the second manufacturing condition when the second structure having the desired shape and density is manufactured.

The predetermined range here is an allowable dimensional difference and density difference assumed by degreasing and sintering. A specific numerical value of the predetermined range can be determined by, for example, an experiment.

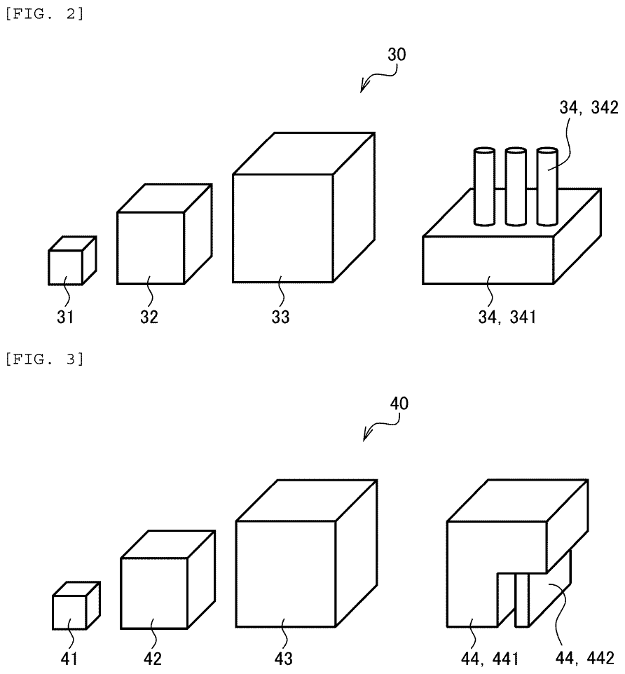

FIG. 3 is a perspective view showing a shape of the silver part 40 to be used for evaluation. For the silver part 40, for example, the silver part 40 is manufactured as the second structure under an initially set second manufacturing condition, and the second condition determination unit 103 determines the second manufacturing condition using the manufacturing condition, the shape and the density of the silver part 40, and the like. Therefore, the silver part 40 shown in FIG. 3 is a structure manufactured for determining the second manufacturing condition.

The silver part 40 (the second structure) includes a plurality of unit structures 41, 42, and 43 having different volumes but a same shape. Therefore, the unit structures 41, 42, and 43 have a similar relationship. The unit structures 41, 42, and 43 have three types of block shapes of large, medium, and small. Therefore, the green part 30 and the silver part 40 have a block shape. The block shape has sides that are made up of straight lines. With the block shape, a length of each side can be easily measured, and the dimensional difference can be easily calculated. Each of the unit structures 41, 42, and 43 is a cube in the shown example. By using the cube, it is possible to measure the dimension in each direction of x, y, and z-axis directions and evaluate the shrinkage in each direction caused by stacking or the like. In addition, the influence can be evaluated by a temperature distribution due to a difference in volume, a thermal stress due to the temperature distribution, the influence of processing unevenness, and the like. However, the shape is not limited to a cube.

The silver part 40 further includes a unit structure 44. The unit structure 44 includes a main body portion 441 having an overhang shape and a support 442 that supports a lower side of the main body portion 441 (in the stacking direction). Therefore, the silver part 40 has an overhang shape. The overhang shape is a shape in which nothing is present below in the stacking direction. For the overhang shape, bonding is weakened by degreasing, and a self-weight deformation due to the shape is likely to occur in the process of increasing the temperature to a sintering temperature. As a result, the shape may greatly change. Therefore, by using the unit structure 44, an influence of such a change can be evaluated.

There is a possibility that the self-weight deformation due to overhang can be somewhat reduced by adjusting a temperature increasing rate or the like. However, in the example according to the present disclosure, it is preferable to consider on the premise that the support 442 is applied under the condition that the self-weight deformation occurs. Therefore, the support 442 is also used in the unit structure 44 to be used as a prototype.

Returning to FIG. 1, the second condition determination unit 103 further determines, as the second manufacturing condition, a manufacturing condition when all density differences in the unit structures 41, 42, and 43 (FIG. 3) are within the predetermined range. For example, when each of the unit structures 41, 42, and 43 is stacked and degreased, the density of each of the unit structures 41, 42, and 43 is lower than the density when the structure in which the powder material is densely present is set to 100%. However, since the shapes are the same but the volumes are different as described above, the degree of decrease may be different for each of the unit structures 41, 42, and 43. Therefore, by determining, as the second manufacturing condition, a manufacturing condition in which all density differences in the unit structures 41, 42, and 43 are within the predetermined range, it is possible to determine the second manufacturing condition in which the density change is substantially the same regardless of the volume. Accordingly, the density change can be reduced regardless of the volumes of the first structure and the second structure.

The second learning unit 104 performs the machine learning using the second manufacturing condition, the shape of the second structure, and the density of the second structure as features. By providing the second learning unit 104, an evaluation result of the second structure associated with degreasing and sintering can be constructed as the database of the learning conditions. The shape here is, for example, a dimension of a side forming the second structure. In the machine learning, for example, supervised learning using the second manufacturing condition as an objective variable and the shape and the density of the final structure as explanatory variables can be executed. However, the learning is not limited to the supervised learning, and may be unsupervised learning or reinforcement learning. As an algorithm of the machine learning, for example, Bayesian optimization, and kernel ridge regression analysis can be used.

The second learning unit 104 performs the machine learning using, as the second manufacturing condition, a manufacturing condition determined by applying a desired shape and density to a thermal deformation analysis model using a thermal property of the first structure and the shape and the density of the second structure. Accordingly, the shape and the density of the second structure can be calculated using the thermal deformation analysis model and the thermal property (for example, a linear expansion coefficient) of the first structure without actually performing the degreasing and the sintering. Further, since the machine learning can be performed using the calculated shape and density of the second structure, learning opportunities in the machine learning can be increased.

In particular, the sintering is a time-consuming process. Therefore, when all conditions are evaluated by an experimental method, it may take time to converge. Therefore, by performing thermal deformation analysis and fitting using the thermal property of the first structure and the shape and the density of the second structure, which are associated with sintering conditions obtained by initial learning, it is possible to analyze the second manufacturing conditions and increase learning opportunities.

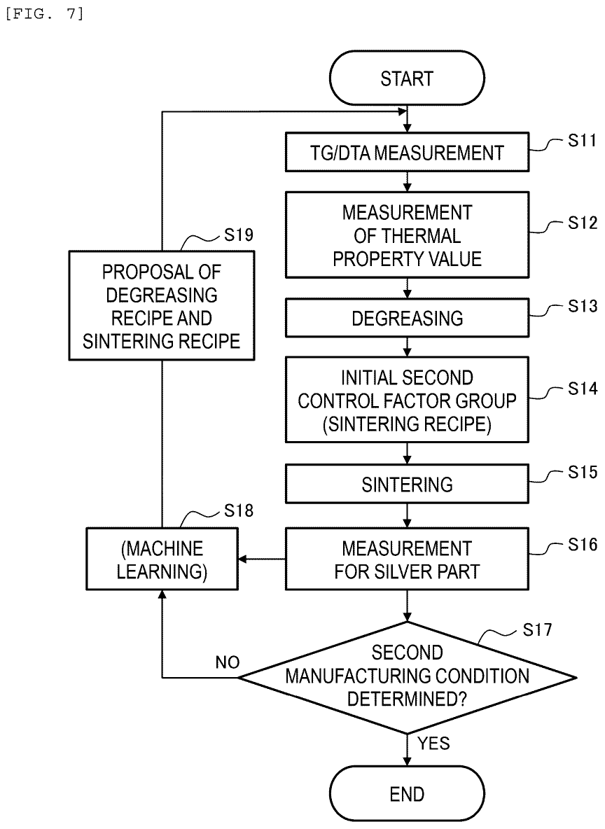

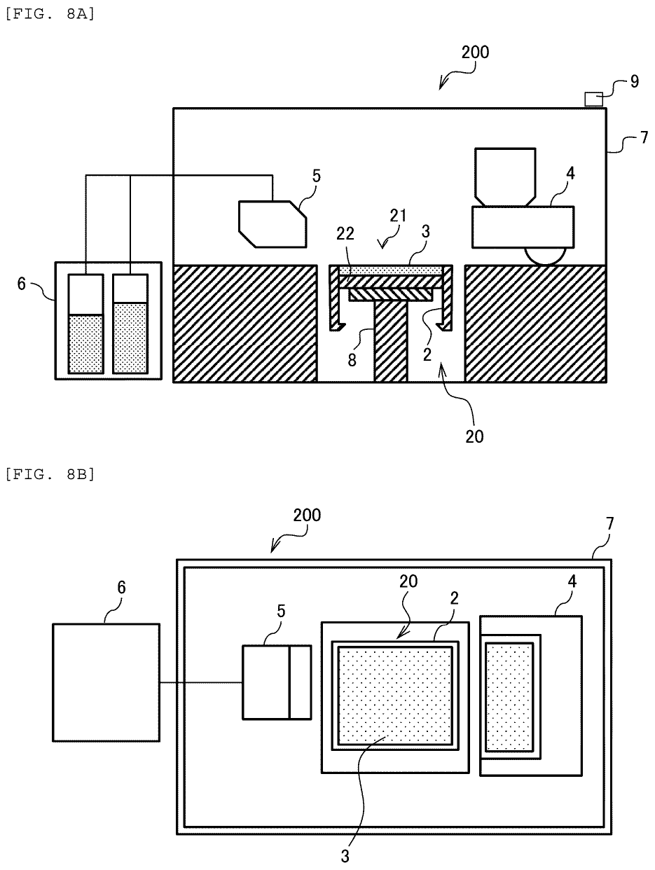

As described above, the additive manufacturing device 200 performs additive manufacturing by the binder jetting method. Specific contents of the additive manufacturing device 200 will be described later with reference to FIG. 8A and subsequent drawings. The additive manufacturing device 200 performs the additive manufacturing based on, for example, the first manufacturing condition and the second manufacturing condition determined by the determination device 100.

Information on the shape and the density of the first structure and the second structure obtained by the additive manufacturing, information on a thermal property value of the intermediate structure, and the like are input to the determination device 100 via the input device 300 by the user, for example. The input device 300 is, for example, a keyboard or a mouse. The first manufacturing condition and the second manufacturing condition determined by the determination device 100 are output to the output device 400 as appropriate. The output device 400 is, for example, a monitor, a display, or a printer.

The determined first manufacturing condition and second manufacturing condition are, for example, manufacturing conditions corresponding to the characteristics of the powder material, the characteristics (functions, specifications, and the like) of the additive manufacturing device 200 to be used, and the shape and density of the final structure that is the desired second structure. Therefore, by performing the additive manufacturing using the additive manufacturing device 200 assumed at the time of condition determination under the determined first manufacturing condition and second manufacturing condition, a structure having a desired shape and density can be manufactured.

FIG. 4 is a flowchart showing an additive manufacturing method according to the present disclosure. The additive manufacturing method according to the present disclosure includes a first condition determination step S101, a second condition determination step S102, and an additive manufacturing step S103.

The first condition determination step S101 is a step of determining the first manufacturing condition based on the shape and the density of the first structure manufactured by stacking and resin curing performed during additive manufacturing by the binder jetting method. As described above, the first manufacturing condition is a manufacturing condition at the time of stacking and resin curing for manufacturing the first structure having a desired shape and density. The first condition determination step S101 can be executed by the first condition determination unit 101 (FIG. 1). The second condition determination step S102 is a step of determining the second manufacturing condition based on the shape and the density of the second structure manufactured by the degreasing and sintering performed during the additive manufacturing. The second manufacturing condition is a manufacturing condition at the time of degreasing and sintering for manufacturing the second structure having a desired shape and density using the manufactured desired first structure as described above. The second condition determination step S102 can be executed by the second condition determination unit 103 (FIG. 1). A first learning step by the first learning unit 102 and the second learning step by the second learning unit 104 may be performed as appropriate.

The additive manufacturing step S103 is a step of manufacturing a structure using the first manufacturing condition determined in the first condition determination step S101 and the second manufacturing condition determined in the second condition determination step S102. The structure here preferably has a condition to be used when determining the first manufacturing condition and the second manufacturing condition. The additive manufacturing device 200 (FIG. 1) used for additive manufacturing also preferably has the conditions to be used when determining the first manufacturing condition and the second manufacturing condition. According to a manufacturing method according to the present disclosure, it is possible to manufacture an additive product (stacked molded object, molded object, structure) having a desired shape and density.

The determination of the manufacturing conditions and the additive manufacturing may be performed at the same place or at different places. In the latter case, for example, the manufacturing condition is determined at a point A, and the additive manufacturing can be performed at a point B using the determined first manufacturing condition and second manufacturing condition. In this case, it is preferable to determine the manufacturing conditions at the point A after obtaining the specifications, characteristics, and the like of the additive manufacturing device 200 used at the point B in advance. In this way, for example, the first manufacturing condition and the second manufacturing condition matching the specifications, characteristics, and the like of the additive manufacturing device 200 installed at the remote point B can be determined by the user present at the point A and provided to a manufacturer present at the point B.

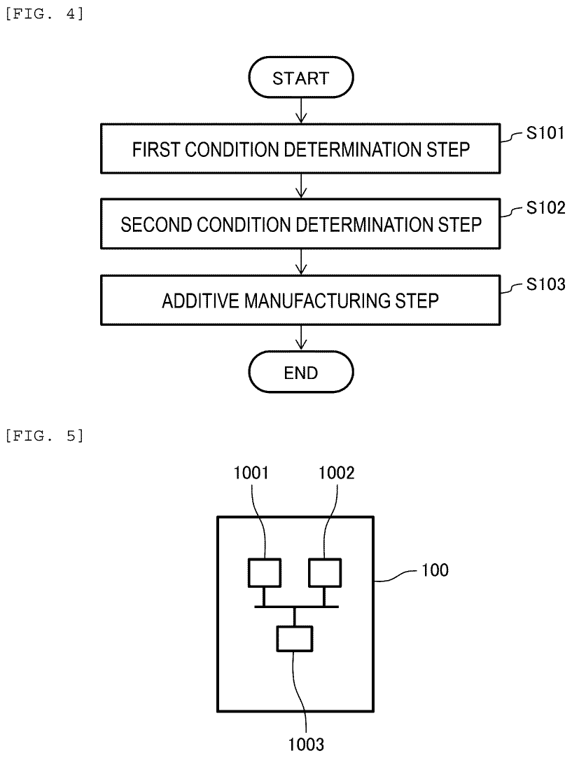

FIG. 5 is a block diagram showing a hardware configuration of the additive manufacturing condition determination device 100 according to the present disclosure. The determination device 100 includes, for example, a central processing unit (CPU) 1001, a random access memory (RAM) 1002, and a read only memory (ROM) 1003. The determination device 100 is implemented by a predetermined control program (for example, an additive manufacturing condition determination method) stored in the ROM 1003 being loaded into the RAM 1002 and executed by the CPU 1001.

FIG. 6 is a flowchart showing a first stage of the additive manufacturing condition determination method according to the present disclosure. The additive manufacturing condition determination method according to the present disclosure includes steps S1 to S9. FIG. 6 mainly shows an example of a method for searching for both steps of the stacking and the resin curing for evaluating the quality of the green part. The quality of the green part can be controlled by a “first control factor” described below with reference to FIG. 6. Therefore, the first manufacturing condition at the time of the stacking and the resin curing is an appropriately set first control factor. The flow shown in FIG. 6 can be executed by the first condition determination unit 101 and the first learning unit 102 (both shown in FIG. 1).

The first control factor during the stacking includes a material, a particle diameter, a particle size distribution, and a binder material of the powder material. However, since these are materials used by an end user, these first control factors are preferably fixed factors. In addition, examples of the first control factor include a stacking thickness for each layer, a supply amount of the powder material (an output, a time, and the like of a vibration mechanism 11 to be described later), a powder spreading speed (a moving speed of a powder spreading mechanism 4 to be described later), a leveling setting (a roller rotation speed and the like), a binder application amount (an ink jet output, an ink jet interval, and the like from an application mechanism 5 to be described later), and drying (an output, a time, and the like of a heater 13 to be described later). In particular, the quality of the green part is particularly influenced by these first control factors. The first control factor may also include a supply rate of the powder material.

The first control factor during the resin curing includes a temperature step of a heat treatment (how many stages the temperature is increased), a temperature increasing rate, a processing temperature, and a holding time.

In order to optimize both steps of the stacking and the resin curing, first, in a stacking step, the first control factor is assigned by being changed, and an initial first control factor group (initially set stacking recipe group) is set (step S1). The initial first control factor group is a group of initial conditions for a predetermined first control factor. The initial first control factor group includes, for example, 10 to 20 manufacturing conditions (parameter sets) in total by changing each of the first control factors during the stacking.

Next, stacking and drying are performed using the initial first control factor group (steps S2 and S3). Further, in the resin curing step, an initial first control factor group (initially set curing recipe group) to which the first control factor is assigned by being changed is set (step S4). The initial first control factor group set here also includes, for example, 10 to 20 manufacturing conditions (parameter sets) in total by changing each of the first control factors during the resin curing. The green part is controlled by performing the resin curing using each of the initial first control factor groups (step S5).

The total number of the first control factors (the number of recipes) during the stacking and the resin curing is a number obtained by multiplying the number of stacking recipes by the number of curing recipes, and the number of evaluations may be enormous. Here, in the resin curing step, the processing temperature is roughly determined by the material of the resin. Therefore, it is preferable to fix the temperature increasing rate and the number of steps first and determine an approximate processing temperature and processing time. The stacking recipe group may be set by using an experimental design method or by determining a swing width based on another material recipe using a material suitable for a metal material to be used during condition determination.

In order to evaluate the quality of the green part, it is preferable to manufacture and evaluate a plurality of green parts by one recipe as described above. The plurality of green parts to be used are, for example, the green parts 30 described above with reference to FIG. 2.

The shape, the mass, and the density of the green parts manufactured using the initially set stacking recipe group and curing recipe group are measured (step S6). The density may be obtained by calculation instead of actual measurement. In the manufactured green part, as described above with reference to FIG. 2, the manufacturing condition close to a target shape is extracted, and further, among these recipes, the manufacturing condition in which the density is high and the difference in volume (large, medium, and small in FIG. 2) and the density difference is small is determined as the first manufacturing condition.

If there is one that achieves the target in the measurement and evaluation of the green part, it is determined that the first manufacturing condition is determined, and both steps of stacking and resin curing can be completed (YES in step S7). However, when the target is not achieved and in the case of confirming whether there is no expectation of further improvement (NO in step S7), initial stacking recipes and curing recipes, and an evaluation result for the shape and the density of the green parts obtained using these recipes are stored in the database of learning conditions, and the machine learning can be performed as described above (step S8). Accordingly, an appropriate combination can be derived.

After the machine learning of step S7 is performed, the stacking recipe and the curing recipe are newly proposed by the machine learning (step S9). Step S1 and subsequent steps are performed again according to the newly proposed stacking recipe and curing recipe.

Steps S1 to S9 described above are a first condition determination step of determining the first manufacturing condition based on the shape and the density of the first structure manufactured by stacking and resin curing performed during additive manufacturing by the binder jetting method. As described above, the first manufacturing condition is manufacturing condition at the time of stacking and resin curing for manufacturing the first structure having a desired shape and density.

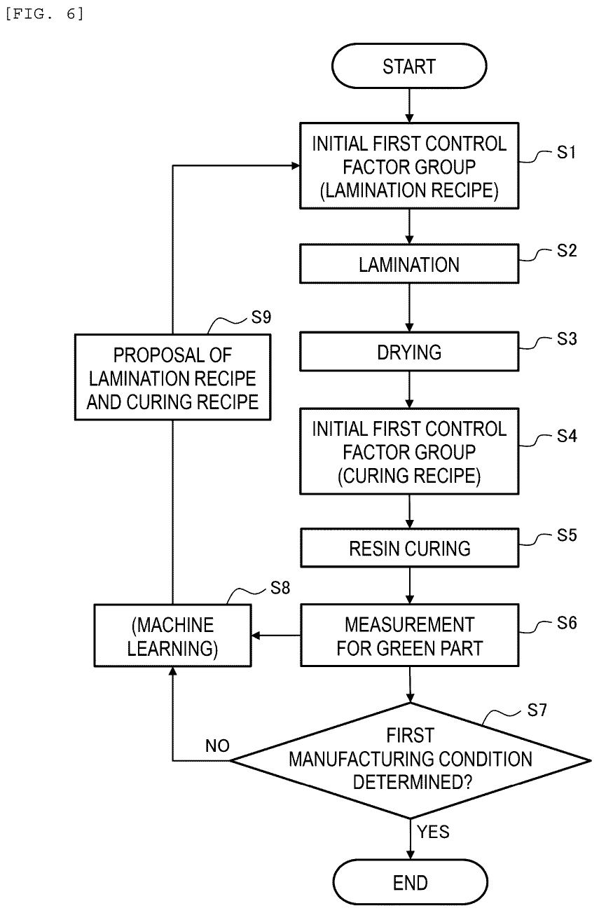

FIG. 7 is a flowchart showing a subsequent stage of the additive manufacturing condition determination method according to the present disclosure. The additive manufacturing condition determination method according to the present disclosure includes steps S11 to S19. The flow shown in FIG. 7 is executed following the flow shown in FIG. 6. FIG. 7 mainly shows an example of a method for searching for both steps of degreasing and sintering for evaluating final quality of the silver part. The final quality of the silver part can be controlled by a “second control factor” described below with reference to FIG. 7. Therefore, the second manufacturing condition at the time of degreasing and sintering is an appropriately set second control factor. The flow shown in FIG. 7 can be executed by the second condition determination unit 103 and the second learning unit 104 (both shown in FIG. 1).

Examples of the second control factor during degreasing include a processing atmosphere, a temperature increasing rate, a processing temperature, and a processing time (holding time). Examples of the second control factor during sintering include a processing atmosphere, a temperature step, a temperature increasing rate, a sintering temperature, and a holding time.

In order to optimize both steps of degreasing and sintering, first, a green part is produced using the first manufacturing condition determined with reference to FIG. 6, and simultaneous thermogravimetric and differential thermal analysis (TG/DTA) is performed on the produced green part (step S11). By analyzing data from simultaneous thermogravimetric and differential thermal analysis, a temperature range in which a mass change occurs due to binder loss can be determined, and thus it is possible to determine a degreasing processing temperature (an example of a degreasing recipe). By maintaining the temperature range in which the mass change occurs during degreasing, breakage of the green part due to an excessively high temperature and insufficient removal of the binder due to an excessively low phoneme can be prevented. Accordingly, the binder can be sufficiently removed, and a brown part can be produced.

The degreasing processing time (an example of the degreasing recipe) can be set with reference to, for example, a binder removal time calculated by a predetermined algorithm based on a record of a thermal mass change. As the predetermined algorithm, for example, a predetermined formula associated with the change rate of the processing temperature and the temperature (an example of the degreasing recipe) at the time of increasing the temperature can be used.

In addition, thermal property values such as a linear expansion coefficient are measured for the produced green part (step S12). The thermal property value here is a property value that affects at least one of the shape and the density of the sintered silver part by heating caused by degreasing and sintering.

Next, the produced green part is degreased (step S13).

After degreasing, an initial second control factor group (initially set sintering recipe group) is set for optimization of sintering (step S14). The initial second control factor group is a group of initial conditions for a predetermined second control factor. The initial second control factor group includes, for example, 10 to 20 manufacturing conditions (parameter sets) by changing each of the second control factors during the sintering. The sintering is performed using the initial second control factor as the second manufacturing condition (step S15). The shape, the mass, and the density of each silver part obtained by the sintering are measured (step S16). The density may be obtained by calculation instead of actual measurement.

In order to evaluate the quality of the silver part, it is preferable to manufacture and evaluate a plurality of silver parts by one recipe as described above. The plurality of silver parts to be used are, for example, the silver parts 40 described above with reference to FIG. 3.

The shape, the mass, and the density of the silver part manufactured using the initially set degreasing recipe group and sintering recipe group are measured (step S16). The density may be obtained by calculation instead of actual measurement. In the manufactured silver part, as described above with reference to FIG. 3, the manufacturing condition close to a target shape is extracted, and further, among these recipes, the manufacturing condition in which the density is high and the difference in volume (large, medium, and small in FIG. 3) and the density difference is small is determined as the second manufacturing condition.

If there is one that achieves the target in the measurement and evaluation of the silver part, it is determined that the second manufacturing condition is determined, and both the degreasing and sintering processes can be completed (YES in step S17). However, when the target is not achieved and in the case of confirming whether there is no expectation of further improvement (NO in step S17), initial degreasing recipes and sintering recipes, and an evaluation result for the shape and the density of the silver parts obtained using these recipes are stored in the database of learning conditions, and the machine learning is performed as described above (step S18). Accordingly, an appropriate combination can be derived. The data to be used in the machine learning in step S18 may be data acquired by the thermal deformation analysis as described above.

After the machine learning of step S18 is performed, the degreasing recipe and the sintering recipe are newly proposed by the machine learning (step S19). Step S12 and subsequent steps are performed again according to a newly proposed degreasing recipe and sintering recipe.

Steps S11 to S19 described above are a second condition determination step of determining the second manufacturing condition based on the shape and the density of the second structure manufactured by the degreasing and sintering performed during the additive manufacturing. The second manufacturing condition is a manufacturing condition at the time of degreasing and sintering for manufacturing the second structure having a desired shape and density using the manufactured desired first structure as described above.

According to the determination device 100 and the determination method described above, a structure (a final structure) having desired shape and density can be manufactured by performing the additive manufacturing under the determined first manufacturing condition and second manufacturing condition. In particular, in the additive manufacturing of the binder jetting method, there are a plurality of manufacturing steps, and there are various control factors such as the first control factor and the second control factor. Therefore, it is not easy to determine a suitable control factor. In order to obtain suitable manufacturing conditions, several molded objects are manufactured and evaluated. Therefore, it takes enormous cost and time to construct a recipe which is a manufacturing condition in each of steps.

On the other hand, in the powder bed fusion described above, there is a method for matching a control factor and a molding result using machine learning, performing regression analysis, and performing optimization. However, even if the method is applied to the binder jetting method, in the binder jetting method, a processing time is required to evaluate a recipe through a series of processes of additive manufacturing conditions. Therefore, the evaluation takes time and the number of evaluations increases, and if the results of the previous process are poor, the analysis does not converge until the search for the appropriate conditions. Therefore, according to the determination device 100 and the determination method according to the present disclosure, since the manufacturing conditions are determined separately for the first manufacturing condition and the second manufacturing condition, it is possible to reduce the time and man-hours until the determination, and to efficiently perform the determination. That is, the search for the additive manufacturing condition in a binder powder method is divided into a plurality of parts, and thus efficiency up to the optimization can be improved.

FIG. 8A is a schematic side view of the additive manufacturing device 200 according to the present disclosure. FIG. 8B is a schematic top view of the additive manufacturing device 200 according to the present disclosure. The additive manufacturing device 200 binds the metal powder by applying a binder to the powder material (a powder bed 3) spread in layers and drying the powder material. The binder is, for example, a solution containing a resin. The binder may further contain additives such as a surfactant and a viscosity modifier in addition to the resin and an organic solvent. Examples of the powder material include powders of metal materials such as hot tool steel, copper, titanium alloy, nickel alloy, aluminum alloy, cobalt-chromium alloy, and stainless steel, powders of resin materials such as polyamide, and powders of ceramics. The additive manufacturing device 200 repeats the formation of the powder bed 3, the binder application, and the drying in this order to form a three-dimensional structure of the metal powder bound by the binder in a molding layer 2.

Fluidity of the metal powder changes due to the influence of humidity. Therefore, moisture can be removed by heating portions with which the powder material comes into contact, such as a powder supply mechanism 10, a leveling mechanism 12, the powder spreading mechanism 4, and the molding layer 2 to be described later, and the humidity can be controlled.

A space functioning as a collection portion 20 is formed around the molding layer 2. The excess powder falls into the collection portion 20 as the powder spreading mechanism 4 performs the powder spreading operation. The powder collected in the collection portion 20 is reused for molding by being reclassified with a sieve.

The additive manufacturing device 200 includes the molding layer 2, the powder spreading mechanism 4, the application mechanism 5 that applies a binder, a supply mechanism 6 that supplies the binder to the application mechanism 5, a chamber 7, and a lifting mechanism 8 that lifts and lowers the molding layer 2. The additive manufacturing device 200 further includes a monitoring device 9 that monitors the operation and control of the additive manufacturing device 200. The monitoring device 9 can adopt, for example, a hardware configuration same as the hardware structure the determination device 100 shown in FIG. 7. The chamber 7 accommodates each mechanism of the additive manufacturing device 200 excluding the monitoring device 9 and the supply mechanism 6. However, the chamber 7 may accommodate the monitoring device 9 and the supply mechanism 6.

A molding region 21 includes the molding layer 2 and a bottom plate 22. The bottom plate 22 is fixed to the lifting mechanism 8, and an up-down direction position of the bottom plate 22 changes according to the operation of the lifting mechanism 8.

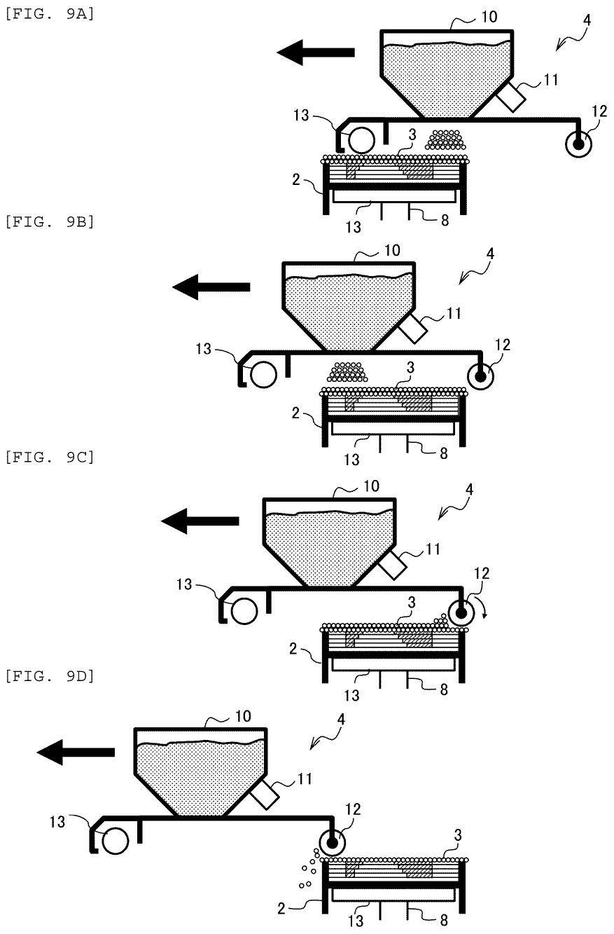

The powder spreading mechanism 4 includes the powder supply mechanism 10, the vibration mechanism 11, the leveling mechanism 12, the heater 13, and a drive mechanism (not shown) that moves the powder spreading mechanism 4, which will be described later with reference to FIG. 9A and the like. The heater 13 may not be provided.

The application mechanism 5 includes a binder head 51 described later and a drive mechanism (not shown) for moving the binder head 51. The binder is supplied from the supply mechanism 6 to the binder head 51 through a pipe (not shown), and the supplied binder is dispensed from the binder head 51.

FIGS. 9A, 9B, 9C, and 9D are schematic views showing an example of the powder spreading operation. The powder spreading is performed in the order of the operations shown in FIGS. 9A, 9B, 9C, and 9D. It is preferable that the powder spreading operation is a part of the stacking step, and the powder spreading operation is performed under a condition included in the first manufacturing condition.

First, the powder spreading mechanism 4 will be schematically described. The powder spreading mechanism 4 causes the powder supply mechanism 10 to vibrate with the vibration mechanism 11 to drop the powder onto the molding layer 2. Further, by moving the powder spreading mechanism 4, the powder is spread in the molding layer 2 via the leveling mechanism 12, and the powder bed 3 is formed. Although not shown, the powder supply mechanism 10 may be provided in a concave shape in an inner bottom of the chamber 7 (FIG. 8A) independently of the powder spreading mechanism 4, and may have an opening at an upper end with an upper portion opened. In this case, the powder supply mechanism 10 preferably has an up-down movable stage for placing and supplying the powder material. The stage constitutes a bottom wall of the powder supply mechanism 10 and is provided to be movable up and down at a predetermined pitch by an appropriate lifting mechanism (not shown).

Next, the powder spreading operation using the powder spreading mechanism 4 will be described. For example, as indicated by thick solid arrows in FIGS. 9A to 9D, the powder spreading operation is started by moving the powder spreading mechanism 4 onto the molding layer 2. As shown in FIG. 9A, the powder spreading mechanism 4 on the molding layer 2 vibrates the powder supply mechanism 10 by the vibration of the vibration mechanism 11 to drop the powder material to be supplied. As shown in FIG. 9B, the powder spreading mechanism 4 drops the powder material while moving, thereby spreading the powder on the molding layer 2. As shown in FIG. 9C, by moving the powder spreading mechanism 4, the leveling mechanism 12 acts on the spread powder to level the powder, thereby forming the powder bed 3. The leveling mechanism 12 is a blade, a roller, or the like that adjusts a height level of the powder bed 3. In the case of a roller, the powder bed 3 can be formed while being pressed and solidified by moving the powder spreading mechanism 4 while rotating the roller. As shown in FIG. 9D, the excess powder material falls from the molding layer 2.

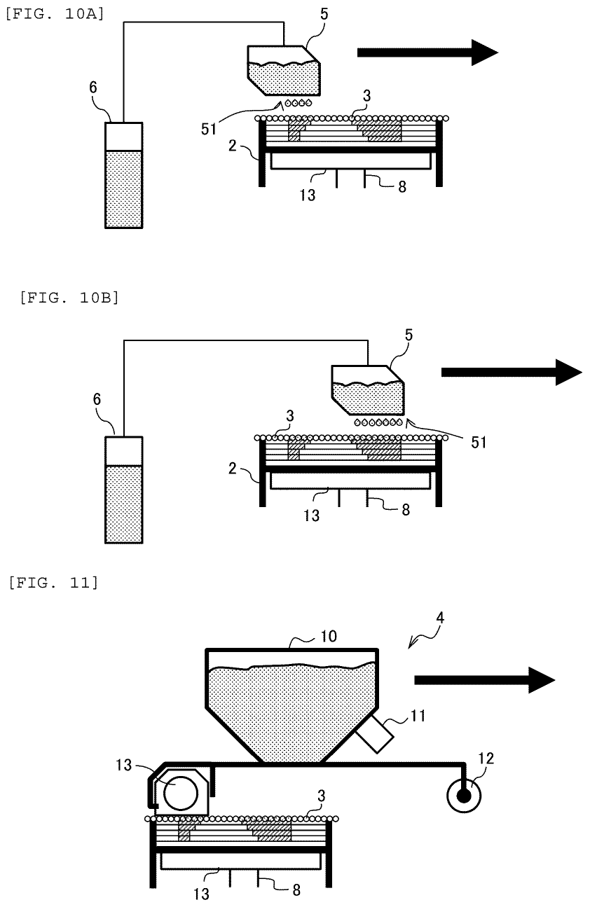

FIGS. 10A and 10B are schematic diagrams showing an example of the application operation. It is preferable that the application operation is a part of the stacking step, and the application operation is performed under a condition included in the first manufacturing condition. As shown in FIG. 10A, the binder is applied to the powder bed 3 formed on the molding layer 2 in accordance with a two-dimensional planar shape corresponding to one layer of a molded object (green part). The application is continuously performed by inkjet from the application mechanism 5 that moves as indicated by thick solid arrows in FIGS. 10A and 10B.

FIG. 11 is a diagram showing an example of the drying operation. It is preferable that the drying operation is a part of the stacking step, and the drying operation is performed under a condition included in the first manufacturing condition. The drying of the applied binder can be performed by heating, for example, the heater 13 moving in the direction indicated by the thick solid arrow and passing the binder on the powder bed 3. The drying may be performed simultaneously with the binder application by continuously heating, with the heater 13, the molding layer 2 or a bottom surface of the molding layer 2.

By repeating the operations shown in FIGS. 9A to 11, the three-dimensional shape of the molded object is formed in the molding layer 2 (FIG. 8A). Then, the binder is cured by holding for several hours to several tens of hours in a temperature range of about 100° C. to 300° C. in a thermostatic bath (not shown) together with the molding layer 2. Accordingly, the green part can be taken out from the powder of the molding layer 2.

The taken out green part is held in a thermostatic bath or a heat treatment furnace (both not shown) in a temperature range of about 400° C. to about 600° C. for several hours to several tens of hours to be degreased. Accordingly, the binder is removed, and a brown part is obtained. The degreasing is preferably performed under conditions included in the second manufacturing condition. In the brown part, since the binding between the powder materials is weakened by the removal of the binder, the shape is easily deformed, and care is required for handling.

The brown part is sintered by being held for several hours to several tens of hours in a temperature range of about 80% of the melting point or less in a vacuum furnace or a heat treatment furnace in a vacuum atmosphere (both not shown). By sintering, the powders of the brown part are metal-bonded to each other, and thus a silver part which is a sintered body is obtained. The sintering is preferably performed under conditions included in the second manufacturing condition. The degreasing and the sintering may be collectively performed in the same furnace.

The brown part may be deformed by its own weight when exposed to a high temperature in the sintering treatment. Therefore, in a portion having the overhang shape, deformation at the time of sintering can be prevented by simultaneously manufacturing a support or the like called a support as described above. It is preferable that the support is installed with a slight gap between the support and the molded object during sintering, and a release agent is applied to an interface so that the support comes into deformation contact and does not bond during sintering.

### REFERENCE SIGNS LIST

100: determination device
101: first condition determination unit
102: first learning unit
103: second condition determination unit
104: second learning unit
200: additive manufacturing device
30: green part
300: input device
31: unit structure
32: unit structure
33: unit structure
34: unit structure
341: support portion
342: pin-shaped portion
40: silver part
400: output device
41: unit structure
42: unit structure
43: unit structure
44: unit structure
441: main body portion
442: support
S101: first condition determination step
S102: second condition determination step
S103: additive manufacturing step

1. An additive manufacturing condition determination device comprising:
a first condition determination unit configured to determine, based on a shape and a density of a first structure manufactured by stacking and resin curing performed during additive manufacturing by a binder jetting method, a first manufacturing condition at the time of the stacking and the resin curing for manufacturing the first structure having a desired shape and density; and
a second condition determination unit configured to determine, based on a shape and a density of a second structure manufactured by degreasing and sintering performed during the additive manufacturing, a second manufacturing condition at the time of the degreasing and the sintering for manufacturing a second structure having a desired shape and density using the manufactured desired first structure.

2. The additive manufacturing condition determination device according to claim 1, wherein
the first condition determination unit determines, as the first manufacturing condition, a manufacturing condition during manufacturing of the first structure under which a dimensional difference and a density difference from a desired shape are both within predetermined ranges.

3. The additive manufacturing condition determination device according to claim 2, wherein
the first structure includes a: plurality of unit structures having different volumes but having a same shape, and
the first condition determination unit further determines, as the first manufacturing condition, a manufacturing condition when a density difference in each of the unit structures is within a predetermined range.

4. The additive manufacturing condition determination device according to claim 1, further comprising:
a first learning unit configured to perform machine learning using the first manufacturing condition, a shape of the first structure, and a density of the first structure as features.

5. The additive manufacturing condition determination device according to claim 1, wherein
each of the first structure and the second structure has a block shape.

6. The additive manufacturing condition determination device according to claim 1, wherein
the first structure includes a pin-shaped portion.

7. The additive manufacturing condition determination device according to claim 1, wherein
the second condition determination unit determines, as the second manufacturing condition, a manufacturing condition during manufacturing of the second structure under which a dimensional difference and a density difference from a desired shape are both within predetermined ranges.

8. The additive manufacturing condition determination device according to claim 7, wherein
the second structure includes a plurality of unit structures having different volumes but having a same shape, and
the second condition determination unit further determines, as the second manufacturing condition, a manufacturing condition in which a density difference in each of the unit structures is within a predetermined range.

9. The additive manufacturing condition determination device according to claim 1, further comprising:
a second learning unit configured to perform machine learning using the second manufacturing condition, a shape of the second structure, and a density of the second structure as features.

10. The additive manufacturing condition determination device according to claim 9, wherein
the second learning unit performs the machine learning using, as the second manufacturing condition, a manufacturing condition determined by applying a desired shape and density to a thermal deformation analysis model using a thermal property of the first structure and the shape and the density of the second structure.

11. The additive manufacturing condition determination device according to claim 1, wherein
the second structure has an overhang shape.

12. An additive manufacturing condition determination method comprising:
a first condition determination step of determining, based on a shape and a density of a first structure manufactured by stacking and resin curing performed during additive manufacturing by a binder jetting method, a first manufacturing condition at the time of the stacking and the resin curing for manufacturing the first structure having a desired shape and density; and
a second condition determination step of determining, based on a shape and a density of a second structure manufactured by degreasing and sintering performed during the additive manufacturing, a second manufacturing condition at the time of the degreasing and the sintering for manufacturing a second structure having a desired shape and density using the manufactured desired first structure.

13. An additive product manufacturing method comprising:
a first condition determination step of determining, based on a shape and a density of a first structure manufactured by stacking and resin curing performed during additive manufacturing by a binder jetting method, a first manufacturing condition at the time of the stacking and the resin curing for manufacturing the first structure having a desired shape and density;
a second condition determination step of determining, based on a shape and a density of a second structure manufactured by degreasing and sintering performed during the additive manufacturing, a second manufacturing condition at the time of the degreasing and the sintering for manufacturing a second structure having a desired shape and density using the manufactured desired first structure; and
manufacturing an additive product using the first manufacturing condition determined in the first condition determination step and the second manufacturing condition determined in the second condition determination step.
